(19) United States
(12) Patent Application Publication
(10) Pub. No.: US 2007/0240581 A1
(43) Pub. Date: Oct. 18, 2007

(54) Hot Beverage Brewing Apparatus

(75) Inventor: Chao Kuang Chen, Hemei Town (TW)

Correspondence Address: MEYER CORPORATION, U.S.;ATTN: EDWARD S. SHERMAN, ESQ., ONE MEYER PLAZA, VALLEJO, CA, 94590, US

(73) Assignee: Meyer Intellectual Properties Limited, Hong Kong (CN)

(21) Appl. No.: 11/733,308

(22) Filed: Apr. 10, 2007

Related U.S. Application Data
(60) Provisional application No. 60/820,255, filed on Jul. 25, 2006.

(30) Foreign Application Priority Data
Apr. 12, 2006 (TW) 95206130

(51) Int. Cl. A47J 31/00

(52) U.S. Cl. 99/279

(57) ABSTRACT

A hot beverage brewing apparatus includes a basket seat, a cup basket, a latch member and a resilient member. The basket seat has a through hole and multiple first protrusions formed in the through hole. The cup basket is mounted on the basket seat and has a downward conical bottom with a center through hole. The latch member is rotatably mounted in the through hole and has a rod, a plug head, multiple inclined guide surfaces that abut respectively on the first protrusions of the base. The rod is movably mounted in the center through hole, and the plug head is connected on the rod. The resilient member is mounted between the cup basket and the latch member. Rotating the cup basket moves the plug head upward or downward relative to the basket seat, which controls opening or closing the center through hole for bleeding the hot beverage.

### CROSS REFERENCE TO RELATED APPLICATIONS

The present application claims priority to the Taiwanese (Republic of China) Patent Application having application number 95206130, entitled “Hot Beverage Brewing Apparatus” and filed Apr. 12, 2006 which is incorporated herein by reference.

The present application also claims priority to the U.S. provisional application having Ser. No. 60/820,255 entitled “Hot Beverage Brewing Apparatus” and filed Jun. 25, 2006, which is incorporated herein by reference.

### BACKGROUND OF INVENTION

The present invention relates to a hot beverage brewing apparatus, and more particularly to a brewing apparatus that is convenient to use, wash and clean.

Brewing apparatus used to brew tea leaves or medicinal herbs has various designs and structures. One type of the brewing apparatus utilizes gravity and pressure of water to control bleeding of hot beverage out of the brewing apparatus to a water reservoir.

The conventional brewing apparatus comprises a cup basket, a filter, a latch plug and an adapter. The cup basket has a body and a connecting portion. The body has a downward conical bottom. The downward conical bottom has a center through hole for bleeding the hot beverage out of the body. The connecting portion is an enclosed wall, is attached to the bottom of the body and has several positioning protrusions and several longitudinal holes.

The filter is mounted on the bottom of the body over the center through hole to separate the hot beverage from the tea leaves or medicinal herbs when the hot beverage is bled.

The latch plug is movably mounted and held in the center through hole of the downward conical bottom and comprises a rod and a plug head. The rod is movably mounted and held in the center through hole and has an upper end and a lower end. The ends are respectively extended out of the center through hole. The plug head has a semi-sphere shape and is attached to the upper end of the rod between the filter and the downward conical bottom of the body. Therefore, the plug head abuts on the downward conical bottom of the body by gravity and seals the center through hole. A user can pour hot water into the body to brew the tea leaves or medicinal herbs to make hot beverage without leakage.

The adapter is mounted on the water reservoir such as a cup or a container and comprises a disk, several positioning studs, a cross rib and a ring member. The disk has a through hole in which the ring member is mounted. The positioning studs are mounted on the ring member outside and are respectively held in the longitudinal holes of the body of the cup basket when the cup basket is connected to and mounted on the adapter. Thus, the positioning pins position the cup basket on the adapter. The cross rib is mounted inside the ring member over the disk of the adapter, and has a center.

When the user needs to bleed the hot beverage out of the body of the cup basket, the user may place the cup basket on the adapter. The lower end of rod of the latch plug abuts against the center of the cross rib in the ring member, which pushes the plug head upward relative to the downward conical bottom of the body of the cup basket. Then, the center through hole in the downward conical bottom is open because of the movement of the plug head. The hot beverage flows through the center through hole of the downward conical bottom of the body, the ring member of the adapter, and eventually into the water reservoir by gravity that the adapter is connected.

However, the conventional hot beverage brewing apparatus can separate hot beverage from the brewed tea leaves or medicinal herbs, the design of the conventional apparatus has some shortcomings.

Since the filter is mounted inside the cup basket, and the cup basket and the adapter are positioned by inserting the positioning studs into the longitudinal holes in the cup basket, the cup basket and the adapter are inconvenient to be assembled when the user uses it. Besides, the user needs to clean and wash those components of the conventional apparatus when the user completes making the hot beverage, the structural design of the conventional brewing apparatus causes inconvenient to disassemble and clean.

The interior of the conventional brewing apparatus is easy to be contaminated after a long term use of making the hot beverage. Therefore, the entire appearance of the conventional brewing apparatus looks unsightly, and raises hygiene problems.

To overcome the shortcomings, the present invention provides an improved hot beverage brewing apparatus to mitigate or obviate the aforementioned problems.

### SUMMARY OF INVENTION

An object of the present invention is to provide a hot beverage brewing apparatus, and the apparatus is easy to assemble and disassemble for use and clean.

Another object of the present invention is to provide a hot beverage brewing apparatus that is convenient to clean and wash.

Another object of the present invention is to provide a hot beverage brewing apparatus that will automatically stop bleeding hot beverage.

A hot beverage brewing apparatus in accordance with the present invention includes a basket seat, a cup basket, a latch member and a resilient member. The basket seat has a through hole and multiple first protrusions formed in the through hole. The cup basket is mounted on the basket seat and has a downward conical bottom with a center through hole for bleeding hot beverage. The latch member is rotatably mounted and held in the through hole and has multiple inclined guide surfaces that abut respectively on the first protrusions of the base. The latch member has a rod and a plug head connected on the rod. The rod is movably mounted and held in the center through hole of the downward conical bottom, and the plug head is mounted on the rod over the center through hole to open or close the center through hole. The resilient member is mounted between the downward conical bottom of the cup basket and the latch member. Rotating the cup basket relative to the basket seat moves the plug head upward or downward relative to the basket seat, which controls opening or closing the center through hole for bleeding the hot beverage.

The above and other objects, effects, features, and advantages of the present invention will become more apparent from the following description of the embodiments thereof taken in conjunction with the accompanying drawings.

### BRIEF DESCRIPTION OF DRAWINGS

FIG. 1 is an exploded, perspective view of a hot beverage brewing apparatus in accordance with the present invention;

FIG. 2 is a perspective view in partial section of the apparatus in FIG. 1;

FIG. 3 is a perspective view in partial section of the apparatus in FIG. 1;

FIG. 4 is an operational, sectional plan view of the apparatus in FIG. 1 when a center through hole for bleeding hot beverage is closed by a plug head;

FIG. 5 is an operational, sectional plan view of the apparatus in FIG. 1 when the plug head opens the center through hole to bleed hot beverage; and

FIG. 6 is an operational, perspective view of the apparatus in FIG. 1 when the apparatus is connected to a water reservoir.

### DETAILED DESCRIPTION

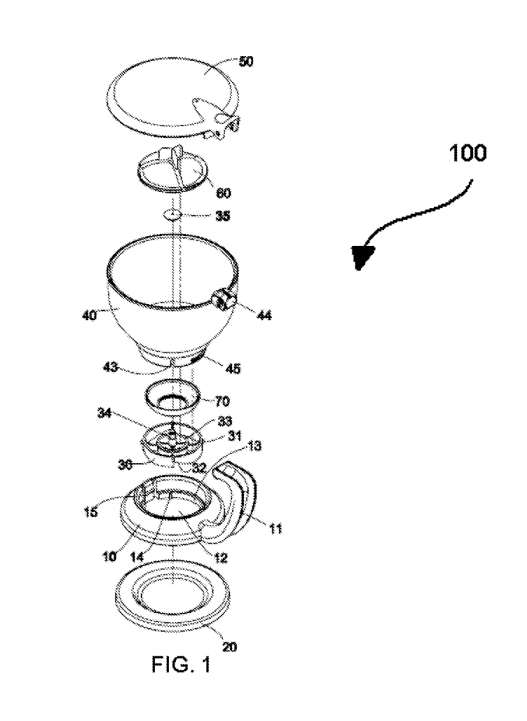

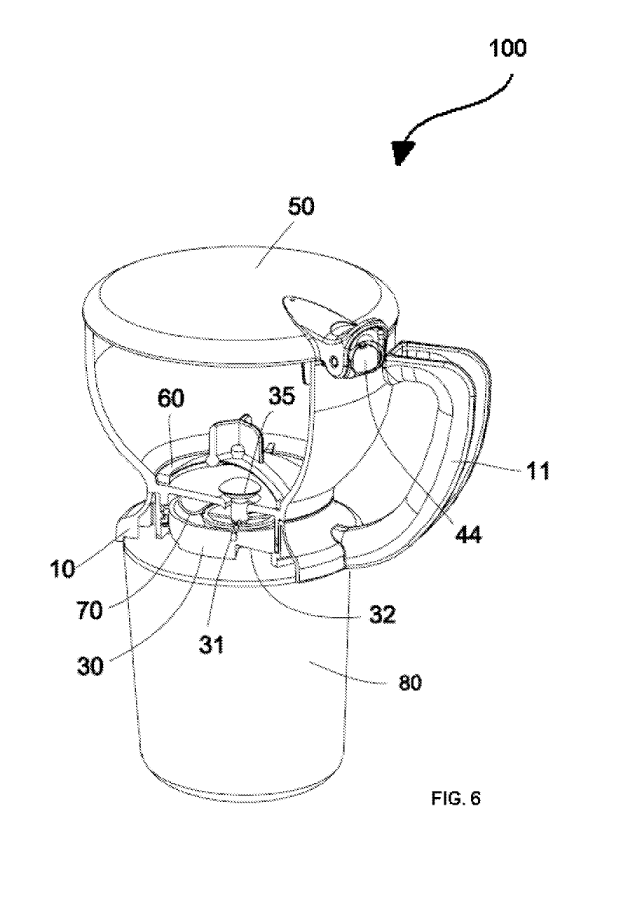

Referring to FIGS. 1 through 6, wherein like reference numerals refer to like components in the various views, there is illustrated therein a new and improved hot beverage brewing apparatus, generally denominated 100 herein.

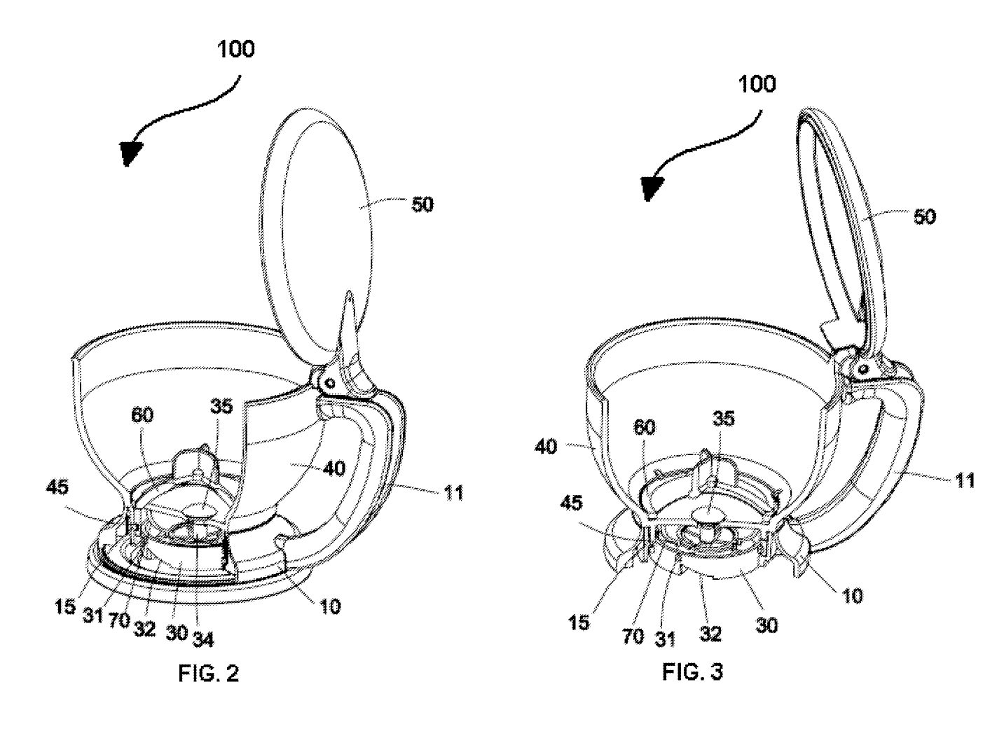

With reference to FIGS. 1 and 2, a hot beverage brewing apparatus 100 in accordance with the present invention comprises a basket seat 10, a pad 20, a latch member 30, a cup basket 40, a cover 50, a filter 60 and a resilient member 70.

The basket seat 10 may be made by plastic injection, is mounted on the pad 20 and comprises a base and a handle 11. The base has a through hole 12, a sliding guide 13, a plurality of first protrusions 14 and two snaps 15. The sliding guide 13 is formed on the base inside the through hole 12. The first protrusions 14 are formed on the sliding guide 13 inside the through hole 12. The snaps 15 are symmetrically mounted on the base inside the through hole 12. The handle 11 is connected to the base of the basket seat 10. The pad 20 may be made of rubber and is used for positioning the brewing apparatus on a surface.

The latch member 30 is rotatably mounted and held in the through hole 12 of the base and comprises an outer ring, a plurality of second protrusions 31, an inner ring 33, a rod 34 and a plug head 35. The latch member 30 may be made by plastic injection. The outer ring has multiple guide surfaces or ramps 32 that are respectively corresponding to the first protrusions 14 of the base so that the guide surfaces 32 will abut respectively on the first protrusions 14 when the latch member 30 is mounted in the through hole 12. The second protrusions 31 are mounted outside this outer ring. The inner ring 33 is mounted inside the outer ring and has a center. The rod 34 is mounted upwardly at the center of the inner ring 33 and has a top end to connect to the plug head 35. It should be appreciated that the guide surfaces or ramps 32 can be on the base rather than the outer ring, in which case the outer ring would have the protrusions 14 to engage with the guide surfaces.

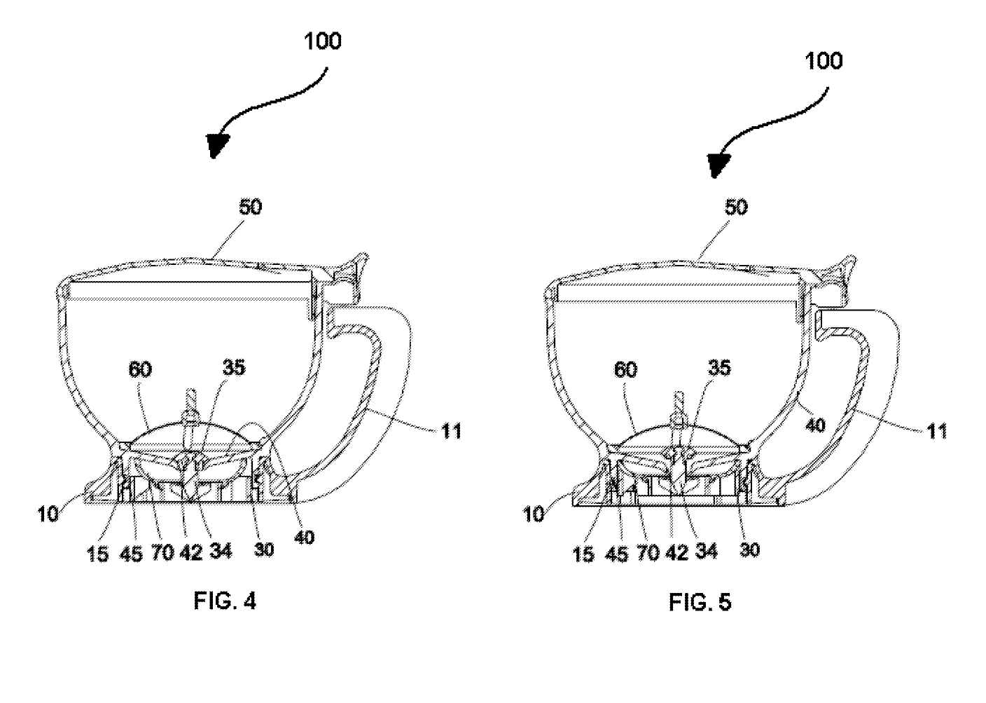

With further reference to FIGS. 3 and 4, the cup basket 40 may be made by plastic injection and has a downward conical bottom 41, a bottom skirt and a joint 44. The downward conical bottom has a center through hole 42 through which the hot beverage held in the cup basket 40 can pass. The bottom skirt is connected around the downward conical bottom 41 and has a plurality of notches 43 and a groove 45. The notches 43 respectively hold the second protrusions 31 of the outer ring, and the groove 45 engages the snaps 15 of the basket seat 10 when the cup basket 40 is mounted on the basket seat 10. Thus, the snaps 15 secure the cup basket 40 with the basket seat 10 in position. The cover 50 is pivotally mounted on the joint 44 and may cover the cup basket 40.

The rod 34 of the latch member 30 is movably mounted and held in the center through hole 42 of the downward conical bottom 41. The top end of the rod extends out of the center through hole 42. The plug head 35 is mounted on the top end of the rod over the center through hole 42 and seals the hole 42 in a normal state because of the resilient member 70. The plug head 35 may be made of silicone rubber or silica gel.

The resilient member 70 is mounted between the downward conical bottom 41 of the cup basket 40 and the latch member 30, and has a conical shape. The resilient member 70 is hollow and connects the downward conical bottom 41 of the cup basket 40 to the inner ring 33 of the latch member 30 to collect the hot beverage bled out of the cup basket 40 through the center through hole 42. The resilient member 70 may be made of silicone rubber or silica gel.

The filter 60 is mounted inside the cup basket 40 over the bottom 41 by threads. The filter 60 will separates the hot beverage from the tea leaves or medicinal herbs when a person pours the hot beverage out of the cup basket 40.

With reference to FIGS. 4, 5 and 6, a user may hold the handle 11, use the thumb to pivot the cover 50 at the joint 44, and open the cup basket 40 when the user needs to brew tea, coffee or other hot beverage. Thus, the user can pour hot water into the cup basket 40 and left it to develop stronger flavor with the tea leaves, medicinal herbs or coffee etc.

When the user needs to bleed out the hot beverage, the apparatus is connected to a water reservoir 80 such as a cup. The user simply rotates the cup basket 40 relative to the basket seat 10 by pushing the joint 44 with the user's thumb. The rotation of the cup basket 40 rotates simultaneously the latch member 30 relative to the basket seat 10 because the notches 43 engage respectively the second protrusions 31. Since the outer ring of the latch member 30 has the guide surfaces 32, the latch member 30 will be simultaneously moved upward relative to the basket seat 10 when the latch member 30 is rotated. The rotation of the latch member 30 causes the first protrusions 14 of the basket seat 10 slide respectively along the guide surfaces 32, which renders the upward movement of the latch member 30 and deforms simultaneously the resilient member 70 to produce a resilient force.

The plug head 35 is simultaneously moves upward relative to the basket seat 10, which opens the center through hole 42 of the downward conical bottom 41 of the cup basket 40. The hot beverage will be bled by gravity through the center through hole 42, the resilient member 70, the inner ring 33 and the basket seat 10, and is eventually collected in the water reservoir 80 for drinking.

When the user releases the joint 44 of the cup basket 40, the resilient force of the resilient member 70 moves the latch member 30 back to its original position. Also, the weight of the cup basket 40 renders downward movement of the latch member 30 relative to the basket seat 10 until the plug head 35 abuts on the downward conical bottom 41 of the cup basket 40. Thus, the plug head 35 closes and seals the center through hole 42 again to stop bleeding. Therefore, the bleeding operation of the hot beverage is automatically stopped.

When the user needs to clean and wash the brewing apparatus, simply pushing the snaps 15 will separate the cup basket 40 from the basket seat 10. Turning the filter 60 will separate the filter 60 from the cup basket 40. The components of the brewing apparatus are easy and convenient to assemble or disassemble so that each component will be completely cleaned. Consequently, either using or cleaning the brewing apparatus in accordance with the present invention is easy and convenient.

While the invention has been described in connection with a preferred embodiment, it is not intended to limit the scope of the invention to the particular form set forth, but on the contrary, it is intended to cover such alternatives, modifications, and equivalents as may be within the spirit and scope of the invention as defined by the appended claims.

1. A hot beverage brewing apparatus comprising:
a) a basket seat having a base, and the base having a through hole and a plurality of first protrusions formed inside the through hole;
b) a latch member rotatably mounted and held in the through hole of the base and comprising
i) a plurality of second protrusions;
ii) a plurality of guide surfaces corresponding respectively to the first protrusions of the base;
iii) a rod having a top end; and
iv) a plug head connected to the top end of the rod;
c) a cup basket mounted on the basket seat and having
i) a downward conical bottom having a center through hole; and
ii) a bottom skirt connected around the downward conical bottom and having a plurality of notches respectively holding the second protrusions of the latch member;
d) a cover pivotally mounted on the cup basket;
e) a filter mounted inside the cup basket over the downward conical bottom of the cup basket; and
f) a resilient member mounted between the downward conical bottom of the cup basket and the latch member, and connecting the downward conical bottom of the cup basket to the latch member;
g) wherein, the rod of the latch member is movably mounted and held in the center through hole of the downward conical bottom, the top end of the rod extends out of the center through hole and the plug head is mounted on the top end over the center through hole to open or close the center through hole.

2. The apparatus as claimed in claim 1, wherein the basket seat further has a handle connected to the base.

3. The apparatus as claimed in claim 1 further comprising a pad for supporting the basket seat.

4. The apparatus as claimed in claim 1, wherein each guide surface of the latch member is an inclined surface.

5. The apparatus as claimed in claim 1, wherein the plug head is made of silicone rubber.

6. The apparatus as claimed in claim 1, wherein the resilient member is made of silicone rubber and has a hollow conical shape.

7. The apparatus as claimed in claim 1, wherein the cup basket further has a joint on which the cover is pivotally mounted.

8. The apparatus as claimed in claim 1, wherein
a) the latch member further has a groove; and
b) the base further has at least one snap engaging the groove when the latch member is mounted in the through hole of the base.

9. A hot beverage apparatus comprising:
a) a circular base ring,
b) a brewing chamber having an upper opening and a central bottom portal nested for rotary engagement within said circular base ring,
c) a seal member in adjustable engagement with the central bottom portal of said brewing chamber,
d) wherein the seal member is coupled to the circular base ring whereby the rotation of the brewing chamber within the circular base ring disengages said seal member such that fluid in the brewing chamber drains through the central bottom portal.

10. A hot beverage apparatus according to claim 9 further comprising a cover for the upper opening of the brewing chamber,

11. A hot beverage apparatus according to claim 10 wherein said cover is pivotally engaged to a hinge extending outward from the periphery of the brewing chamber.

12. A hot beverage apparatus according to claim 9 further comprising a handle that extending outward from said circular base ring.

13. A hot beverage apparatus according to claim 9 further comprising a filter for detachable sealed engagement within said brewing chamber.

14. A hot beverage apparatus according to claim 9 wherein the seal member comprises an annular base nested within the circular base ring and disposed below the brewing chamber.

15. A hot beverage apparatus according to claim 14 wherein the annular base further comprises centrally disposed rod that extend upward to a support a plug that closes the central bottom portal of the brewing chamber.

16. A hot beverage apparatus according to claim 15 wherein a series of spokes extend in from the annular base to support the centrally disposed rod.

17. A hot beverage apparatus according to claim 9 wherein at least one of the seal member and the circular base ring comprises a plurality of radially disposed ramps to engage a mating portion of the other member not comprising the ramps to urge the seal member upward when the brewing chamber is rotated with respect to said circular base.

18. A hot beverage apparatus according to claim 14 wherein the seal member comprises a centrally disposed plug mounted on a rod extending through the central bottom portal.
